(19) United States
(12) Patent Application Publication
(10) Pub. No.: US 2009/0164710 A1
(43) Pub. Date: Jun. 25, 2009

(54) SEMICONDUCTOR MEMORY SYSTEM AND ACCESS METHOD THEREOF

(75) Inventors: Jin-Hyeok Choi, Yongin-si (KR); Duck-Hyun Chang, Seoul (KR); Jun-Jin Kong, Yongin (KR); Dong-Hyuk Chae, Seoul (KR); Seung-Jae Lee, Hwaseong-si (KR); Dong-Ku Kang, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/340,846

(22) Filed: Dec. 22, 2008

(30) Foreign Application Priority Data
Dec. 20, 2007 (KR) 2007-134342

(51) Int. Cl. G06F 12/02; G06F 12/00

(52) U.S. Cl. 711/103; 711/E12.001; 711/E12.008

(57) ABSTRACT

A semiconductor memory system and access method thereof. The semiconductor memory system includes a nonvolatile memory and a memory controller. The nonvolatile memory stores monitoring data in one or more of plural memory cells. The memory controller controls the nonvolatile memory. The memory controller detects the monitoring data and adjusts a bias voltage, which is provided to the plural memory cells, in accordance with a result of the detection.

### CROSS-REFERENCE TO RELATED APPLICATIONS

This U.S. non-provisional patent application claims priority under 35 U.S.C. §119 of Korean Patent Application No. 10-2007-0134342 filed on Dec. 20, 2007, the entire contents of which are incorporated herein by reference.

### BACKGROUND OF THE INVENTION

1. Field of the Invention

The present general inventive concept relates to a semiconductor and a system to control the semiconductor memory. More particularly, the present general inventive concept relates to a semiconductor memory system with improved reliability and an access method thereof.

2. Description of the Related Art

Semiconductor memory devices are used for reserving data. Semiconductor memory devices are generally classified into volatile and nonvolatile types. Volatile memory devices lose their data if power supply is interrupted thereto, while nonvolatile memory devices retain their data even without power supply therein.

Since nonvolatile memory devices are able to store data in small power, there are mostly spotlighted as storage media for portable apparatuses. There is a flash memory device as a kind of nonvolatile memory. Hereinafter will be concerned with the flash memory device as a model, whereas the description may be relevant over other nonvolatile styles, e.g., phase-change random access memory (PRAM), ferroelectric RAM (FRAM), magnetic RAM (MRAM), and so on.

FIG. 1 is a sectional diagram illustrating a memory cell of a flash memory device. Referring to FIG. 1, a source S and a drain D of the memory cell are formed in a semiconductor substrate, interposing a channel region therebetween. A floating gate is formed over the channel region, interposing a thin dielectric film therebetween. A control gate G is formed over the floating gate, interposing an intergate dielectric film therebetween. The source S, the drain D, the floating gate, and the semiconductor substrate are connected to terminals for applying voltages to them in programming, erasing, and reading operations.

In the flash memory device, data are read out by discriminating threshold voltages of the memory cells. A threshold voltage of the memory cell is determined by a quantity of electrons accumulated in the floating gate. As many as electrons stored in the floating gate, the threshold voltage becomes higher.

Electrons of the floating gate would leak toward the arrow direction of FIG. 1 due to various reasons. Above all, electrons may leak from the floating gate by external impulses (e.g., heat). Further, electrons are released from the floating gate due to wearing of the memory cell. Repetition of an access operation to the flash memory device is the most reason of wearing the dielectric film between the channel region and the floating gate. The access operation includes the programming, erasing, and reading operations.

FIG. 2 is a diagram illustrating threshold voltage distributions of the memory cells. Referring to FIG. 2, the vertical axis denotes threshold voltages Vth and the horizontal axis denotes the number of memory cells. If the memory cells are single level cells (SLCs), the memory cell is conditioned in one of two states S0 and S1.

When a read voltage Vr is applied to the control gates of the memory cells (refer to FIG. 1), memory cells of the state SO are turned on while the other memory cells of the state S1 are turned off. If a memory cell is turned on, a current flows through the memory cell. If a memory cell is turned off, there is no current through the memory cell. Therefore, data is distinguished by turn-on or off of the memory cell. Accordingly, threshold voltages of memory cells must be maintained constantly in order to accurately measure states of data stored in the memory cells. However, as mentioned above, the threshold voltages of memory cells may be lowered due to external environments and/or wearing.

FIG. 3 is a diagram illustrating a case that the threshold voltages of memory cells of FIG. 2 are lowered by an uncertain level. Referring to FIG. 3, solid curves represent initial threshold voltages of memory cells and a dotted curve represents threshold voltages lowered by external environments and/or wearing. The memory cells belonging to a shadow area are detected as being in the state S0 by the lowered threshold voltages, although the threshold voltages have been programmed for the state S1. This result incurs read failures, thereby degrading reliability of the semiconductor memory device.

A change of threshold voltages makes operational troubles especially to multi-level cells (MLCs). A unit MLC is designed to store pluralities of data bits in purpose of enhancing the integration density of the semiconductor memory device.

FIG. 4 is a diagram illustrating threshold voltage distributions of 3-bit level memory cells. Referring to FIG. 4, the 3-bit level cell is conditioned in one of eight states S0-S7. S0 is an erased state and S1 through S7 indicate programmed states. Compared to the SLCs, the MLCs are arranged with narrower margins between the respective threshold voltages. Because of that, it would incur a serious problem from minor fluctuation of threshold voltages in the MLCs.

FIG. 5 is a diagram illustrating a case that threshold voltages of the 3-bit level memory cells of FIG. 4 are lowered. Referring to FIG. 5, solid curves represent initial threshold voltages of memory cells and a dotted curve represents threshold voltages lowered by external environments and/or wearing. The lowered threshold voltages cause read failures in the memory cells corresponding to the shadow area.

### SUMMARY OF THE INVENTION

The present general inventive concept provides a semiconductor memory system with improved reliability by conducting an access operation in consideration of variation of cell characteristics. Furthermore, the present general inventive concept also provides an access method of a semiconductor memory system able to carry out memory access by considering variation of cell characteristics.

Additional aspects and utilities of the present general inventive concept will be set forth in part in the description which follows and, in part, will be obvious from the description, or may be learned by practice of the general inventive concept.

In an embodiment and utilities of the present general inventive concept, there is provided a semiconductor memory system including a nonvolatile memory to store monitoring data in one or more of plural memory cells, and a memory controller to control the nonvolatile memory. The memory controller may detect the monitoring data and adjust a bias voltage, which is provided to the plural memory cells, in accordance with a result of the detection.

The memory controller may detect the monitoring data and adjust the bias voltage at a power-on time of the semiconductor memory system.

The plural memory cells may be grouped into pluralities of blocks and the monitoring data are each comprised in the blocks. The memory controller may the monitoring data corresponding to the block while reading data from the block. The memory controller may store the monitoring data into a spare field of the block. The memory controller may store the monitoring data into the spare field that has the least error rate in the block.

The memory controller may store a result of the detection of the monitoring data. The bias voltage may be a read voltage. The monitoring data may correspond to one of plural threshold-voltage states of the memory cells. The memory controller may detect the plural threshold-voltage states and adjust the bias voltage in accordance with a detection result of the states.

The monitoring data may be data about an erasing count of the plural memory cells. The memory controller may detect the erasing count and adjust the bias voltage in accordance with a detection result of the erasing count. The memory controller, if the number of read failures is greater than a reference count of the memory cells, may detect the monitoring data and adjust the bias voltage in accordance with a result of the detection. The memory controller may detect the read failure by means of error correction codes. The monitoring data corresponds to one of the plural threshold-voltage states of the memory cells.

In an embodiment and utilities of the present general inventive concept, there is also provided an access method of a semiconductor memory system. The method may include storing monitoring data in one or more of plural memory cells, detecting the monitoring data, and adjusting a bias voltage, which is provided to the plural memory cells, in accordance with a result of the detection.

The monitoring data may be stored while programming data cells. Detecting the monitoring data may be carried out at a power-on time. The plural memory cells may be grouped into pluralities of blocks and the monitoring data may be each included in the blocks. The monitoring data may be detected in correspondence with the block while reading the block. The monitoring data may be detected if the number of read failures of the memory cells is greater than a reference count.

The semiconductor memory system according to the present general inventive concept conducts an access operation with considering cell characteristics variable by external environments and/or wearing.

In an embodiment and utilities of the present general inventive concept, there is also provided an electronic apparatus including a semiconductor memory system having a nonvolatile memory to store monitoring data in one or more of plural memory cells, and a memory controller to control the nonvolatile memory, the memory controller detecting the monitoring data and adjusting a bias voltage, which is provided to the plural memory cells, in accordance with a result of the detection, and a processor to process data read from the semiconductor memory system according to the adjusted bias voltage.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a sectional diagram illustrating a memory cell of a flash memory device;

FIG. 2 is a diagram illustrating threshold voltage distributions of the memory cells;

FIG. 3 is a diagram illustrating a case that threshold voltages of the memory cells shown in FIG. 2 are lowered in level;

FIG. 4 is a diagram illustrating threshold voltage distributions of 3-bit level memory cells;

FIG. 5 is a diagram illustrating a case that threshold voltages of the 3-bit level memory cells shown in FIG. 4 are lowered;

FIG. 6 is a block diagram illustrating a semiconductor memory system according to an embodiment of the present general inventive concept;

FIG. 7 is a diagram illustrating a method of detecting threshold voltages of monitoring cells;

FIGS. 8 through 10 are block diagrams illustrating a semiconductor memory system according to an embodiment of the present general inventive concept;

FIGS. 11 and 12 are flow charts illustrating access methods of the memory systems of FIGS. 6, 8, and 10; and

FIG. 13 is a block diagram illustrating a computing system with the semiconductor memory system according to an embodiment of the present general inventive concept.

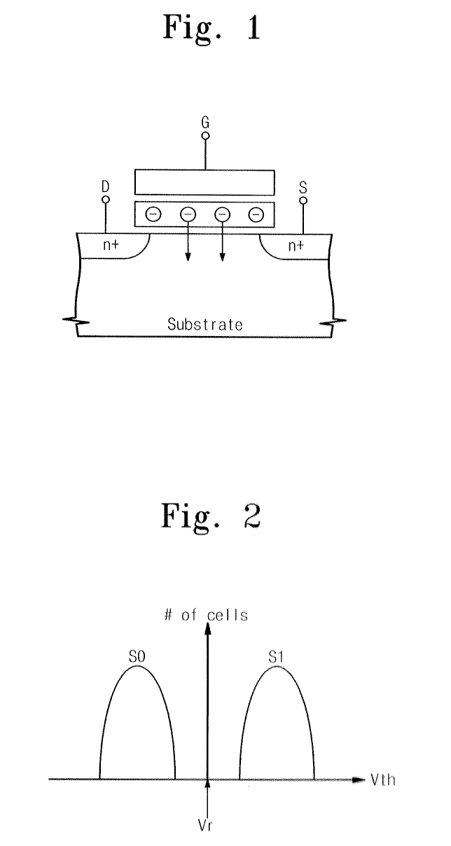

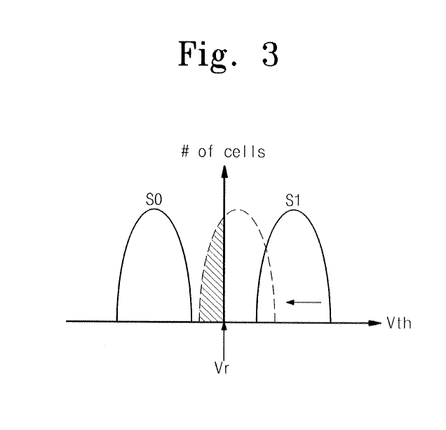

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

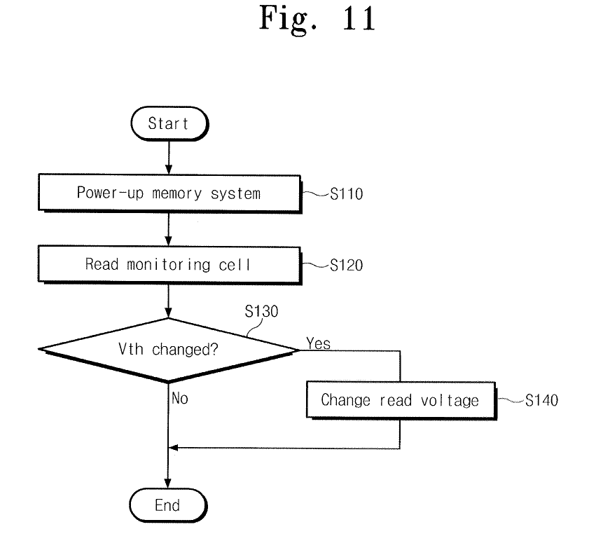

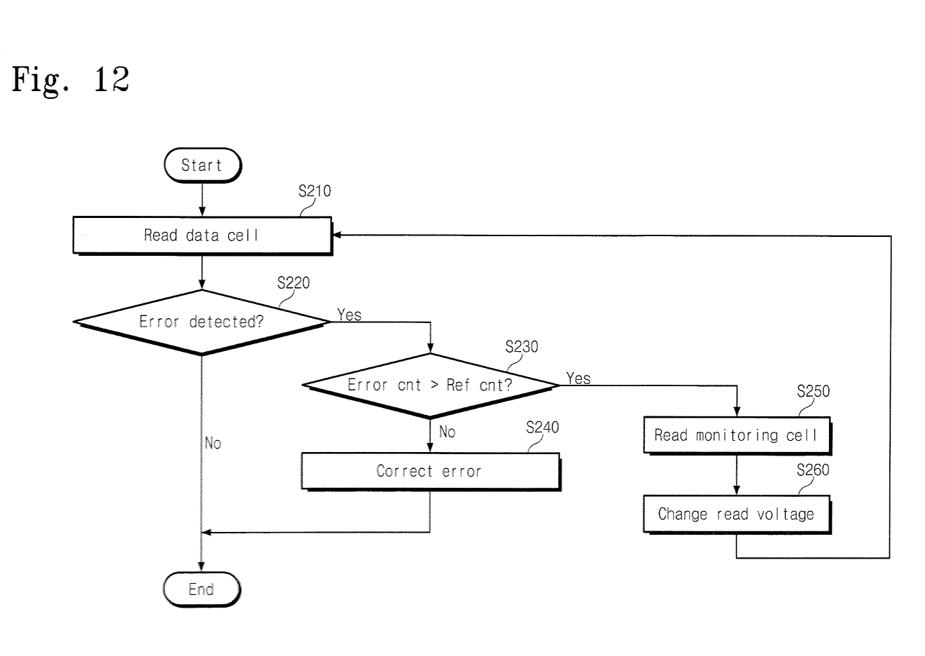

Hereinafter, it will be described about memory systems (FIGS, 6 through 10) and access methods (FIGS. 11 and 12) in conjunction with the accompanying drawings. In these embodiments of the present invention, the semiconductor memory may include another type of nonvolatile memories such as PRAM, MRAM, charge-trap flash (CTF) memory, and so forth.

In the present general inventive concept, access voltages are trimmed in consideration of cell characteristics varying by external environments and/or wearing. Here, the access voltages are voltages applied to memory cells during the reading, programming, and erasing operations. Variation of cell characteristics (e.g., threshold voltage) is detected by referring to monitoring cells (M/C) of a memory cell array or the number of erasing times, which will be detailed hereinbelow.

FIG. 6 is a block diagram illustrating a semiconductor memory system 100 according to an embodiment of the present general inventive concept. Referring to FIG. 6, the semiconductor memory system 100 includes a nonvolatile memory device 110 and a memory controller 120. The nonvolatile memory device 110 includes a memory cell array 130, a row selector 140, an input/output (I/O) circuit 150, a voltage generator 170, and a control logic circuit 160. Now will be described a reading operation of the nonvolatile memory device 110. But, the present general inventive concept is not limited thereto. The present general inventive concept can be applicable to programming and/or erasing operations of a memory device.

The nonvolatile memory device 110 and the memory control 120 may be connected by one or more wired or wireless external communication lines to receive and transmit signals and/or data. It is possible that the nonvolatile memory device 110 and the memory control 120 can be formed in an integrated single body. In this case, the one or more wired or wireless external communication lines may be data or signal bus.

The memory cell array 130 includes pluralities of memory blocks BLK1˜BLKn. Although not illustrated in FIG. 6, each memory block BLK1˜BLKn includes memory cells disposed on a matrix of rows (or word lines) and columns (or bit lines). The memory cells may be arranged in a NAND or NOR structure logically.

The row selector 140 drives selected and unselected rows in response to row addresses (not illustrated). A drive voltage is generated from the voltage generator 170. During the reading operation, the row selector 140 applies a read voltage Vr to a selected row while applies a pass voltage Vpass to one or more unselected rows.

The input/output circuit 150 functions as a sense amplifier in the reading operation. During the reading operation, the input/output circuit 150 reads out data from the memory cells of the memory cell array 130. Data read out by the input/output circuit 150 is transferred to a trimming circuit 180.

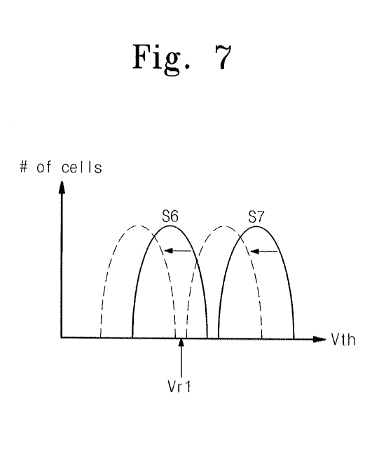

The trimming circuit 180 detects a threshold voltage change of a monitoring cell M/C of the memory cell array 130 in response to data provided from the input/output circuit 150. A method of detecting a threshold voltage change of the monitoring cell M/C by the trimming circuit 180 will be detailed with reference to FIG. 7 later. The trimming circuit 180 applies a trimming command Tr_cmd to the control logic circuit 160 in accordance with a threshold voltage change of the monitoring cell M/C.

The control logic circuit 160 controls the voltage generator 170 to generate a trimmed level of the drive voltage (rising or falling) in correspondence with variation of threshold voltage. The drive voltage generated by the voltage generator 170 is maintained on a constant level until applying the trimming command Tr_cmd or a reset command thereto.

In the present embodiment, at least one of the memory cells of the memory cell array 130 can be used to monitor memory cell characteristics. For instance, a portion of the memory cells of a system data area can be used to monitor the characteristics of the memory cells. The system data area is used by the memory controller 120 for management of the semiconductor memory system 100.

Here, the memory cells used for the monitoring are defined as monitoring cells. The memory cells except the monitoring cells M/C can be defined as data cells. Threshold voltages of the data cells are determined with reference to threshold voltages of the monitoring cells M/C. Since the monitoring cells are disposed adjacent to the data cells, it is possible to determine/detect that threshold voltages of the data cells have been lowered along with a change or decrease of threshold voltages of the monitoring cells. The monitoring cells M/C may be provided entirely or partly to pages of the memory block.

Referring to FIG. 6, the monitoring cells M/C can be placed in a portion of pages of the block BLK1. Detecting the memory cell characteristics can be more effective and correctable according to the number of the monitoring cells M/C. However, in this case. it could reduce a storage capacity of the memory device (i.e., it decreases the number of the data cells). Thus, the number of the monitoring cells can be determined according to the accuracy of detecting the memory cell characteristics and the storage capacity.

It is possible that the area restrictions involved in the monitoring cells can be resolved as follows. A unit memory block is divided into a data field and a spare field. The spare field may reserve parity information of error correction code (ECC) and information necessary for systems. Since unused areas of the spare field can be used as the monitoring cells M/C, it is possible to provide a space for the monitoring cells without reduction of the storage capacity.

Moreover, a size of the parity information can be reduced by storing the error correction codes of a lower level in pages, which have smaller error rates, among plural pages of the memory block. Therefore, the spare field secured in the memory block can be used for the monitoring cells M/C. As an example, if a specific page is lower than a normal page in error rate, the normal pages can be allocated to a 16-bit error correction code while the specific page is allocated to an 8-bit error correction code. Thus, an unused space of the spare field extends since a required size of the parity information becomes smaller. Such an unused spare field can be used for the monitoring cells, resulting in an increase of the storage capacity of the memory cell array 130.

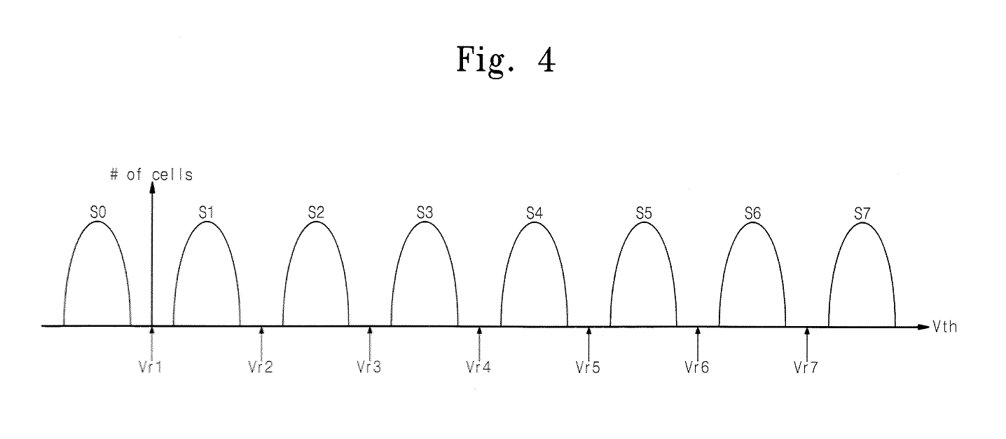

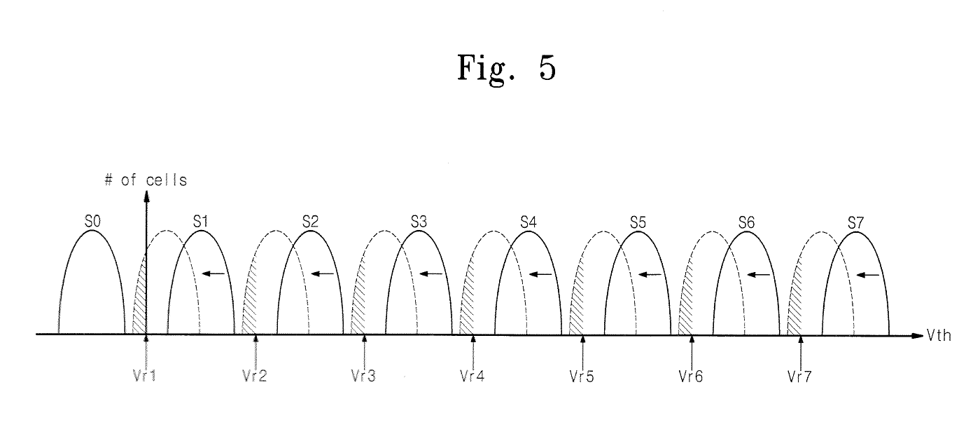

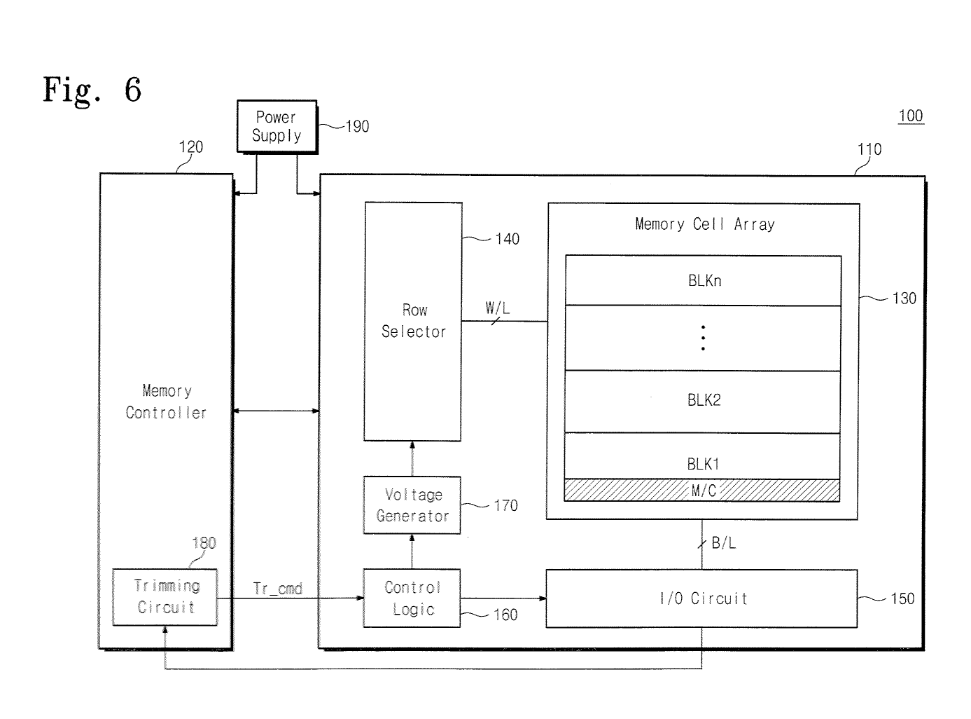

The monitoring cells M/C are preliminarily programmed to have specific threshold voltages. In other words, the monitoring cells M/C are programmed to have monitoring data corresponding to threshold voltages of the normal memory cells. The monitoring cells M/C can be programmed to have a corresponding threshold voltage state. For instance, a portion of the monitoring cells M/C may be programmed to have threshold voltages belonging to the state S1 as illustrated in FIG. 4 and the other portion of the monitoring cells M/C may be programmed to have threshold voltages belonging to the state S2 as illustrated in FIG. 4. Since the monitoring cells M/C are programmed while programming the data cells, characteristic changes of the data cells can be detected by the monitoring cells M/C.

According to the present general inventive concept, the monitoring cells M/C are sensed at a power-up time of the semiconductor memory system 100. Thus, characteristic changes of the memory cells can be detected during a period from when the monitoring cells M/C were programmed until a power-up of the semiconductor memory system. The monitoring cells M/C are programmed at the same time with their corresponding block. And, the monitoring cells M/C can be sensed while conducting the first reading operation to a specific memory area (e.g., a memory block). Finally, an operation of the monitoring cells M/C can be performed if the number of read failures is greater than a reference number.

When the non-volatile memory device 110 and the memory controller 120 are separately supplied with power, independently supplied from different power sources, or selectively turned on and off, it is possible that the monitoring operation of the monitoring cells M/C can be performed at a power-up time of at least one of the non-volatile memory device 110 and the memory controller 120. Here, the power-up time may represent a time when at least one of the non-volatile memory device 110 and the memory controller 120 is supplied with power or turned on according to the supplied power.

Therefore, the semiconductor memory system 100 may further have a power supply 190 to supply power to the non-volatile memory device 110 and the memory controller 120. The power can be supplied from the power supply 190 to the memory controller 120, and then the supplied power is supplied from the memory controller 120 to the non-volatile memory device 110 through the above-described communication line connected between the non-volatile memory device 110 and the memory controller 120. It is also possible that the power supply 190 may be a plurality of power supplies to independently or selectively supply the power to the corresponding ones of the non-volatile memory device 110 and the memory controller 120. The power supply 190 may be formed with the non-volatile memory device 110 and the memory controller 120 in an integrated single body. It is also possible that the power supply 190 is formed as a separate unit to be connected to the semiconductor memory system 100.

FIG. 7 is a diagram illustrating a method of detecting threshold voltages of the monitoring cells M/C. Referring to FIG. 7, solid curves denote initial threshold voltages and broken lines denote threshold voltages lowered by external environments and/or wearing. While this embodiment illustrated the threshold voltages which are lowered, the present general inventive concept is not limited thereto. It is also applicable to a case that threshold voltages are elevated, changed, or adjusted by external impulses and the others.

In the reading operation of the monitoring cells M/C, the read voltage is used. The read voltage is applied to control gates of the monitoring cells. The read voltage can be maintained during the reading operation. However, the read voltage can be variable in a predetermined boundary. According to variation of the reading voltage, a portion of the monitoring cells M/C can be turned off and the other portion of the monitoring cells M/C can be turned on.

According to variation of the read voltage, the numbers of the monitoring cells M/C turned on and off are changed. By statistically analyzing the numbers of the monitoring cells M/C turned on and off, a change of the threshold voltages can be detected from the monitoring cells M/C. For instance, in a case of programming the monitoring cells M/C into the states S6 and S7 respectively, the read voltage Vrd1, which makes the least variation on the numbers of the monitoring cells M/C turned on and off, is set to a medium value of the changed distribution of the threshold voltages. This evaluation is carried out by means of the trimming circuit 180.

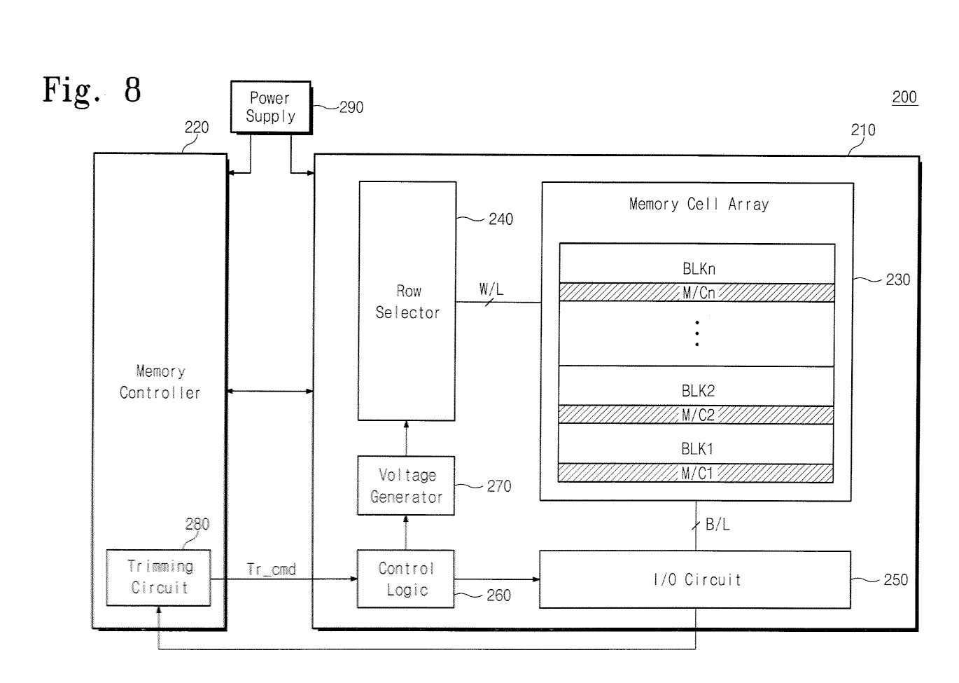

FIG. 8 is a block diagram illustrating a semiconductor memory system 800 according to an embodiment of the present general inventive concept. Referring to FIG. 8, the semiconductor memory system 200 includes a memory controller 210 and a nonvolatile memory device 210. The memory controller 210 may include a trimming circuit 280, and the nonvolatile memory device 210 may include a memory cell array 230, a row selector 240, an I/O circuit 250, a control logic 260, and a voltage generator 270. The above-described elements of FIG. 8 may be similar to element of FIG. 6. Therefore, detailed descriptions thereof will be omitted. Different from the configuration of FIG. 6, the memory blocks BLK1˜BLKn of the memory cell array of FIG. 8 each include the monitoring cells M/C1˜M/C respectively. Thus, accuracy of detecting variation of cell characteristics can be increased from each block.

The semiconductor memory system 200 may further include a power supply 290. The power supply 290 of FIG. 8 may be similar to the power supply 190 of FIG. 6. Therefore, detailed descriptions thereof will be omitted.

Additionally, at a power-up time of the semiconductor memory system 200, the reliability of the semiconductor memory system 200 is improved by simply detecting the threshold voltages of the monitoring cells M/C from a portion of the memory blocks.

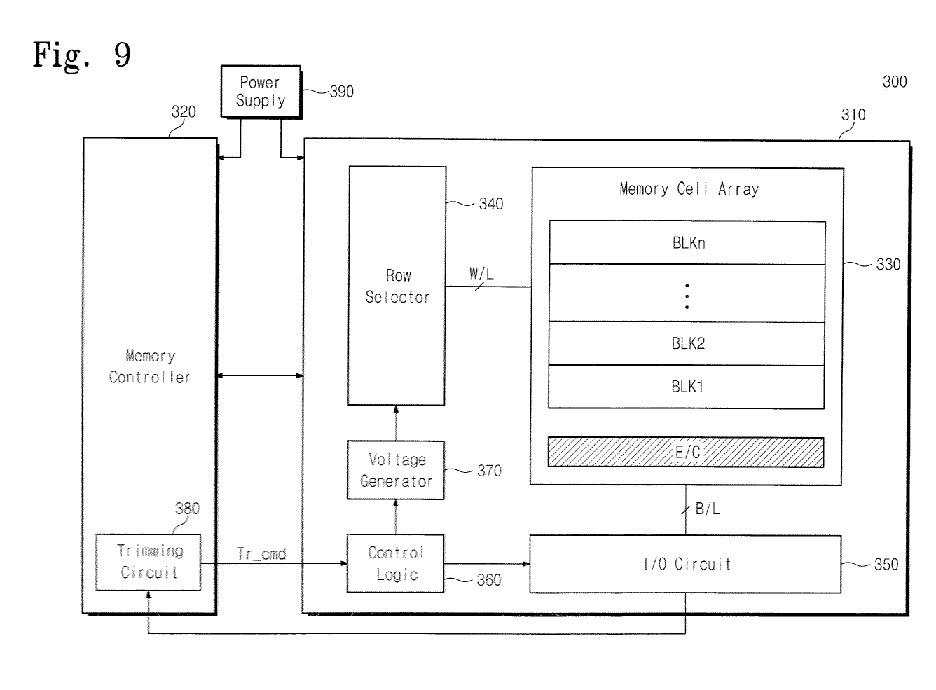

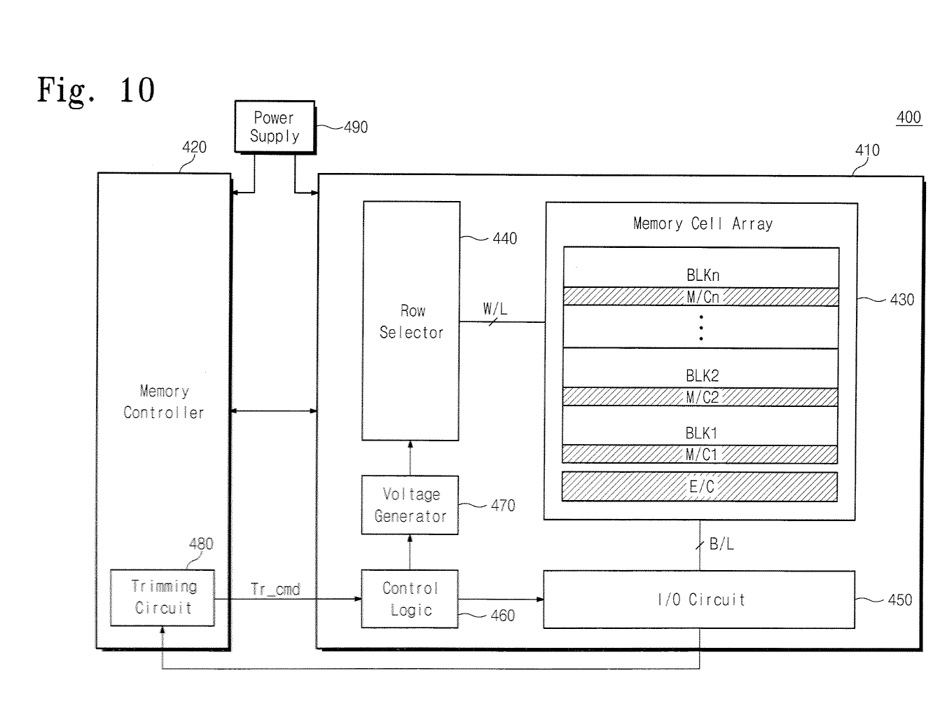

FIG. 9 a block diagram illustrating a semiconductor memory system 300 according to an embodiment of the present general inventive concept. Referring to FIG. 9, the semiconductor memory system 300 includes a nonvolatile memory device 310 and a memory controller 320. The nonvolatile memory device 310 includes a memory cell array 330, a row selector 340, an input/output (I/O) circuit 350, a control logic circuit 360, and a voltage generator 370. The above-described elements of FIG. 8 may be similar to element of FIG. 6. Therefore, detailed descriptions thereof will be omitted.

The semiconductor memory system 300 may further include a power supply 390. The power supply 390 of FIG. 9 may be similar to the power supply 190 of FIG. 6. Therefore, detailed descriptions thereof will be omitted.

The semiconductor memory system 300 of FIG. 9 may be different from the configuration of FIG. 6, in that the memory cell array 330 of FIG. 9 stores information about an erasing count (E/C). The erasing count (E/C) can be stored in an arbitrary location of the memory cell array 330. The erasing count (E/C) means the number of times for erasing the memory block. The erasing count (E/C) is referred in detecting a threshold voltage change of the data cells. If the erasing count (E/C) of the memory block is greater than a reference (i.e., if the memory block is worn down to degrade a required or desired function), the threshold voltages of the memory cells in the block are rapidly lowered. The erasing count (E/C) may be written in a partial area of the memory block or in a system data field of the memory cell array 330.

When the memory cell array 330 receives a command from the memory controller 320 to perform an erasing operation, the memory cell array 330 counts the number of commands to perform the erasing operations to generate the erasing count (E/C) and/or to store the erasing count (E/C) in a portion of memory cells of the memory cell array 330.

FIG. 10 is a block diagram illustrating a semiconductor memory system 400 according to an embodiment of the present general inventive concept. Referring to FIG. 10, the semiconductor memory system 400 includes a nonvolatile memory device 410 and a memory controller 420. The nonvolatile memory device 400 has a memory cell array 430, a raw selector 440, an input/output circuit (I/O) 450, a control logic circuit 460, and a voltage generator 470. The above-described elements of FIG. 8 may be similar to element of FIG. 6. Therefore, detailed descriptions thereof will be omitted.

The semiconductor memory system 400 may further include a power supply 490. The power supply 490 of FIG. 10 may be similar to the power supply 190 of FIG. 6. Therefore, detailed descriptions thereof will be omitted.

The memory blocks BLK1˜BLKn of the memory cell array 430 shown in FIG. 10 are comprised of the monitoring cells M/C1˜M/Cn respectively. Thus, it is able to correctly detect a change of cell characteristics from each block. Additionally, an erasing count (E/C) is stored in the memory cell array 430. As a result, threshold voltages of the data cells are stored in the memory cell array (E/C) by considering the monitoring cells M/C and the erasing count E/C.

FIG. 11 is a flow chart illustrating an access method of a semiconductor memory system illustrated in FIG. 6, 8 or 10. Referring to FIG. 11, the access method of the semiconductor memory system is carried out by including a power-up operation of the semiconductor memory system in operation S110, reading the monitoring cells in operation S120, detecting a change of threshold voltages in operation S130, and trimming the read voltage in operation S140.

The monitoring cells M/C are preliminarily programmed so as to correspond to a specific state of threshold voltage. Therefore, characteristic variations of the data cells can be detected by the monitoring cells M/C. As aforementioned, the monitoring cells M/C can be programmed to have the same threshold voltage or differently from each other.

In operation S110, the semiconductor memory system is powered up (or turned on). This power-up operation is conducted while booting the semiconductor memory system. After programming the monitoring cells M/C, the semiconductor memory system is bootable by various timings. For example, the semiconductor memory system is bootable along with a host. The semiconductor memory system is also bootable when it is connected to the host.

In operation S120, it detects a threshold voltage from the monitoring cell M/C. Referring to the threshold voltage of the monitoring cell M/C, it determines a level of the read voltage applied to the data cells. A sequence of detecting the threshold voltage of the monitoring cell M/C has been described in conjunction with FIG. 7, so it will not be further detailed. While detecting the threshold voltage from the monitoring cell beings at the power-up time of the semiconductor memory system, it may be conducted in the block reading operation.

In operation S130, it is determined whether the threshold voltage of the monitoring cells M/C has been changed. Unless the threshold voltage of the monitoring cell M/C has been changed, the procedure is terminated without trimming a level of the read voltage. If the threshold voltage of the monitoring cell M/C has been changed, the step S140 is carried out.

In operation S140, the read voltage is trimmed in level by a threshold voltage change of the monitoring cell M/C. If the threshold voltage of the monitoring cell M/C becomes lower, it drops the read voltage applied to the data cells. To the contrary, if the threshold voltage of the monitoring cell M/C becomes higher, it elevates the read voltage applied to the data cells. Afterward, the reading operation is executed to the data cells by means of the read voltage that is trimmed or maintained in level.

Summarily, a threshold voltage of the monitoring cell M/C is detected at a power-up time of the semiconductor memory system. According to a result of detection of threshold voltage, the read voltage applied to the data cells is trimmed to enhance the reliability of the reading operation in the semiconductor memory system. Although this embodiment illustrates the monitoring cells M/C as a unit to monitor the threshold voltage change, it is possible to use the erasing count (E/C) to perform the detecting and/or to determine the change of the threshold voltages.

FIG. 12 is a flow chars illustrating access methods of the memory systems of FIGS. 6, 8, and 10. Referring to FIG. 12, the access method is carried out by including reading the data cells in operation S210, finding read failures in operation S220, determining the number of read failures in operation S230, correcting the read failures in operation S240, reading the monitoring cells in operation S250, and trimming the read voltage in operation S260. The threshold voltage of the monitoring cell M/C is detected when an error count is more than a reference count. The reference count is set to be smaller than the largest number of read failures that are correctable in a designed capacity. For instance, if the correctable number of read failures is permitted in 8, the reference count can be set to 6. Thus, the read voltage can be trimmed before error correction or adjustment of the threshold voltages is impossible.

In operation S210, the reading operation begins to read the data cells. The read voltage applied to the data cells may be a default voltage or have a level trimmed by the former method of FIG. 11.

If a read failure is detected in operation S220, the procedure goes to the operation S230. If there is no detection of read failure from operation S220, the access operation is terminated. Read failures can be detected by various ways. For instance, read failures can be found out by means of error correction codes (ECCs). The ECCs can be stored in the memory cell array of the semiconductor memory device. During the reading operation, a data error is detected by comparing a stored ECC to a newly generated ECC.

In operation S230, it determines whether an error count is larger than the reference count. For example, the error count can be detected by means of the ECC. Unless the error count is larger than the reference count, the procedure goes to the operation S240. If the error count is larger than the reference count, the operation S250 begins.

In operation S240, read failures are repaired. Correcting the read failures can be conducted by means of the ECCs.

In operation S250, it detects a threshold voltage of the monitoring cell M/C. It is able to discriminate/detect threshold voltages of the data cells with reference to the threshold voltage of the monitoring cell M/C. If the threshold voltage of the monitoring cell M/C sensed as being lower than before, it determines that the threshold voltages of the data cells are also lowered.

In operation S260, according to a change of threshold voltage from the monitoring cell M/C, the read voltage applied to the data cells is trimmed. If the threshold voltage of the monitoring cell M/C is lowered, the read voltage applied to the data cells becomes lower in level. To the contrary, if the threshold voltage of the monitoring cell M/C is elevated, the read voltage applied to the data cells becomes higher in level. After the operation S260, the operation S210 is resumed. This access method continues until there is no read fail from the data cells. But there would be a problem of infinitely repeating the access operation because a physical defect of the data cell cannot be repaired by the error correction and read-voltage trimming. Therefore, it is necessary to confine the repetition of the access operation in a predetermined number.

The embodiments illustrated in FIGS. 11 and 12 can be performed together. In other words, the embodiment of FIG. 11 may be carried out at the power-up time of the semiconductor memory system and the embodiment of FIG. 12 may be carried out in the reading operation of the semiconductor memory system. With the aforementioned methods, the semiconductor memory system is improved in reliability, without lengthening a power-up time of the semiconductor memory system, by varying a level of the read voltage only if read fails are generated over the reference count.

Additionally, a readout result of the monitoring cells can be stored in a storage unit (e.g., a static random access memory) which may be included in the memory controller 120. Hence, it is possible to reduce the repletion times of operations for reading the monitoring cells.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

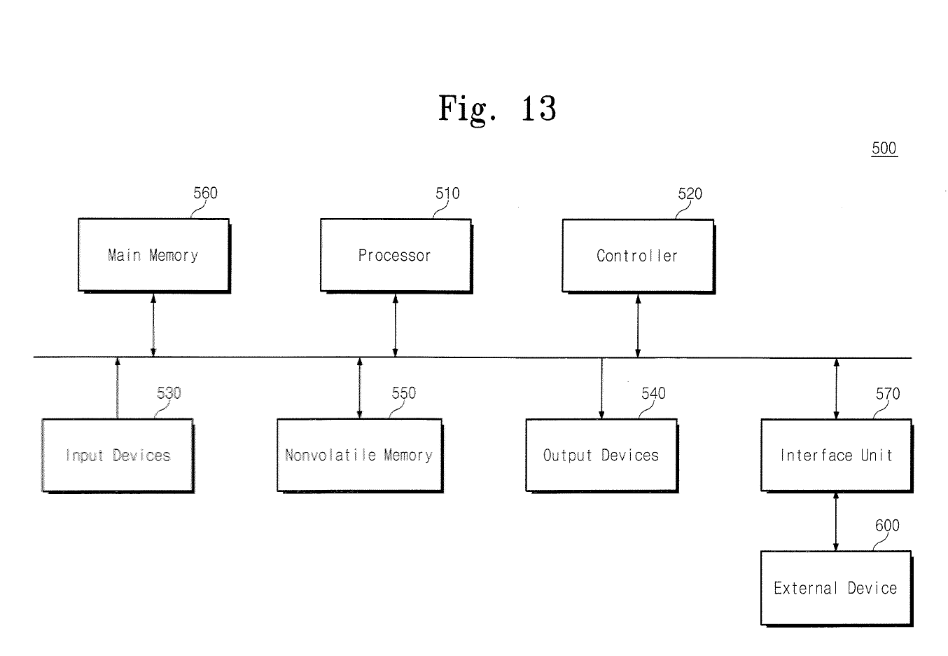

FIG. 13 is a block diagram illustrating a computing system with the semiconductor memory system as an electronic apparatus according to an embodiment of the present general inventive concept.

Referring to FIG. 13, the computing system 500 includes a processor 510, a controller 520, input units 530, output units 540, a nonvolatile memory 550, and a main memory unit 560. In the figure, a solid line denotes a system bus through which signals, data or commands are transferred.

The computing system 500 according to the present general inventive concept inputs data through the input units 530 (e.g., keyboards or cameras). The input data may be a command by a user or multimedia data such as image data taken by an input source or a recording source, for example, a camera. The input data is stored in the nonvolatile memory 550 or the main memory unit 560.

A result processed by the processor 510 is stored in the nonvolatile memory 550 or the main memory unit 560. The output units 540 output data from the flash memory 550 or the main memory unit 560. For example, the output units 540 output data in visible forms for humans. For example, the output units 540 include display devices or speakers.

The nonvolatile memory 550 is operable in the access method according to the present invention. Along with the reliability of the nonvolatile memory 550, the reliability of the computing system 500 will be improved in proportion thereto.

The nonvolatile memory 550 and/or the controller 520 can be mounted on the computing system 500 by way of various types of packages. For instance, the nonvolatile memory 550 and/or the controller 520 may be settled thereon by any package type, e.g., Package-on-Package (PoP), Ball Grid Arrays (BGAs), Chip Scale Packages (CSPs), Plastic Leaded Chip Carrier (PLCC), Plastic Dual In-line Package (PDIP), Die in Waffle Pack, Die in Wafer Form, Chip-On-Board (COB), CERamic Dual In-line Package (CERDIP), Plastic Metric Quad Flat Pack (MQFP), Thin Quad Flat Pack (TQFP), Small Outline (SOIC), Shrink Small Outline Package (SSOP), Thin Small Outline (TSOP), Thin Quad Flat Pack (TQFP), System In Package (SIP), Multi-Chip Package (MCP), Wafer-level Fabricated Package (WFP), Wafer-level Processed Stack Package (WSP), or Wafer-level Processed Package (WSP).

Although not illustrated, it can be understood by those skilled in the art that a power supply is required to supply power to the computing system 500. And, if the computing system 500 is a mobile device, it may be further required of a battery to supply power thereto. It is also possible that the power supply of FIGS. 6, and 8-10 can be used as the power supply to supply the power to the computing system 500.

The semiconductor memory system according to the present general inventive concept is applicable to a solid state drive (SSD). The SSD can be used as the non-volatile memory 550 or the main memory 560. It is also possible that the SSD can be detachable attached to the computing system 500. The SSD can be used together with HDD to form a package as the non-volatile memory 550 or the main memory 560.

The semiconductor memory system according to the present general inventive concept may be used as a portable storage device. Thus, it can be used as a storage device for an MP3 player, a digital camera, a personal digital assistant (PDA), or an e-book. Further, it can be used as a storage unit for a digital TV or computer.

The output devices 540 may perform an output function or operation of the computing system 500. For example, when the computing system 500 is an image processing and/or forming apparatus, the output device 540 may perform an image processing and/or forming operation to process and/or form data of the image. If the computing system 500 is a data generating apparatus, the output device 540 may perform a data generating operation to process data in a required or desired form corresponding to a function of the computing system 500.

The computing system 500 may further include an interface 570 to communicate with an external device 600 to receive or transmit data. The interface 570 may be connected to the external device 600 through a wired or wireless communication line.

As described above, the semiconductor memory system according to the present general inventive concept is able to detect a change of characteristics (threshold voltages) from by means of monitoring means (e.g., monitoring cells or erasing count). Thereby, it improves the reliability of access operation by trimming an access voltage (i.e., read voltage) in accordance with the changed cell characteristics.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A semiconductor memory system comprising:
a nonvolatile memory to store monitoring data in one or more of plural memory cells; and
a memory controller to control the nonvolatile memory,
wherein the memory controller detects the monitoring data and adjusts a bias voltage, which is provided to the plural memory cells, in accordance with a result of the detection.

2. The semiconductor memory system of claim 1, wherein the memory controller detects the monitoring data and adjusts the bias voltage at a power-on time of the semiconductor memory system.

3. The semiconductor memory system of in claim 1, wherein the plural memory cells are grouped into pluralities of blocks and the monitoring data each included in the corresponding blocks.

4. The semiconductor memory system of in claim 3, wherein the memory controller detects the monitoring data corresponding to the block while reading data from the block.

5. The semiconductor memory system of claim 3, wherein the memory controller stores the monitoring data into a spare field of the block.

6. The semiconductor memory system of claim 5, wherein the memory controller stores the monitoring data into the spare field that has the least error rate in the block.

7. The semiconductor memory system of claim 1, wherein the memory controller stores a result of the detection of the monitoring data.

8. The semiconductor memory system of claim 1, wherein the bias voltage is a read voltage.

9. The semiconductor memory system of claim 1, wherein the monitoring data corresponds to one of plural threshold-voltage states of the memory cells.

10. The semiconductor memory system of claim 9, wherein the memory controller detects the plural threshold-voltage states and adjusts the bias voltage in accordance with a detection result of the states.

11. The semiconductor memory system of claim 1, wherein the monitoring data is data about an erasing count of the plural memory cells.

12. The semiconductor memory system of claim 11, wherein the memory controller detects the erasing count and adjusts the bias voltage in accordance with a detection result of the erasing count.

13. The semiconductor memory system of claim 1, wherein the memory controller, if the number of read failures is greater than a reference count of the memory cells, detects the monitoring data, and adjusts the bias voltage in accordance with a result of the detection.

14. The semiconductor memory system of claim 13, wherein the memory controller detects the read fails by means of error correction codes.

15. The semiconductor memory system of claim 13, wherein the monitoring data corresponds to one of the plural threshold-voltage states of the memory cells.

16. An access method of a semiconductor memory system, comprising:
storing monitoring data in one or more of plural memory cells;
detecting the monitoring data; and
adjusting a bias voltage, which is provided to the plural memory cells, in accordance with a result of the detection.

17. The method of claim 16, wherein the monitoring data is stored while programming data cells.

18. The method of claim 16, wherein detecting the monitoring data is carried out at a power-on time.

19. The method of claim 16, wherein the plural memory cells are grouped into pluralities of blocks and the monitoring data is each comprised in the blocks.

20. The method of claim 19, wherein the monitoring data is detected in correspondence with the block while reading the block.

21. The method of claim 16, wherein the monitoring data is detected if read fails of the memory cells are generated over a reference count.

22. An electronic apparatus comprising:
a semiconductor memory system including:
a nonvolatile memory to store monitoring data in one or more of plural memory cells, and
a memory controller to control the nonvolatile memory, the memory controller detecting the monitoring data and adjusting a bias voltage, which is provided to the plural memory cells, in accordance with a result of the detection; and
a processor to process data read from the semiconductor memory system according to the adjusted bias voltage.
